(19) United States
(12) Patent Application Publication
(10) Pub. No.: US 2016/0275542 A1
(43) Pub. Date: Sep. 22, 2016

(54) DIFFERENTIAL REWARD PROVISION METHOD AND APPARATUS

(71) Applicant: SK Planet Co., Ltd., Gyeonggi-do (KR)

(72) Inventor: Jongho KIM, Gyeonggi-do (KR)

(73) Assignee: SK Planet Co., Ltd., Gyeonggi-do (KR)

(21) Appl. No.: 15/073,837

(22) Filed: Mar. 18, 2016

(30) Foreign Application Priority Data
Mar. 18, 2015 (KR) 10-2015-0037563

(51) Int. Cl. G06Q 30/02

(52) U.S. Cl. CPC G06Q 30/0232

(57) ABSTRACT

The point provision apparatus is connected to one or more user terminal and one or more affiliated store terminal through a network, inquires user information based on purchase information when the purchase information is received from the affiliated store terminal, and determines whether to provide an additional point and provides the determined result to the affiliated store terminal by confirming whether to satisfy a reward condition based on the inquired user information and the received purchase information. Accordingly, a satisfaction for consumption behavior of a customer can be increased, and also sales of the affiliated store can be increased by promoting the consumption behaviors of much more customers.

### CROSS-REFERENCE TO RELATED APPLICATION

This application claims priority to and the benefit of Korean Patent Application No. 10-2015-0037563 filed in the Korean Intellectual Property Office on Mar. 18, 2015, the entire contents of which are incorporated herein by reference.

### TECHNICAL FIELD

The present invention relates to technology of providing a differential reward for a use of an on-line/off-line service, and more particularly, to a differential reward provision method and apparatus capable of providing a differential reward according to a differential point reward service providing a differential point by setting a reward condition based on a user condition and a purchase condition compared with user information and purchase information.

### BACKGROUND

Contents described in this section merely provide background information for exemplary embodiments of the present invention, and do not construct a conventional art.

Generally, a marketing method using a bonus point is a marketing means for activating a purchase of a customer and securing the customer having high loyalty, and is a method of providing the bonus point such as a point or a mileage as a predetermined amount or ratio according to a purchase or use result and of allowing the customer to use for a purchase of a product or a use of a service later.

However, since the bonus point is provided as the predetermined amount or ratio according to the purchase or use result, there is a problem in which a lot of costs and time are consumed since the customer has to purchase many products or uses the service continuously in order to accumulate sufficient points capable of using as all or a portion of a payment cost when purchasing the product or using the service later using the bonus point.

In order to solve the problem related to the bonus point service, a method of accumulating an additional point besides a basic point is considered.

That is, the method sends a paper coupon, an electronic coupon, etc. to a member so as to allow the member to accumulate the additional point, and when the member purchases the product or uses the service and presents a corresponding coupon, the additional point is accumulated by processing the corresponding coupon in a point-of-sale (POS) terminal.

However, the paper coupon which is printed is easy to be faked and there are inconveniences in which the customer presents the paper coupon after separately keeping the paper coupon, and a scanner capable of scanning the electronic coupon has to be further included in a conventional POS terminal.

### PRIOR ART

### Patent Document

Korean Patent Publication No. 10-2005-0092682 (Published on Sep. 22, 2005, entitled “customized coupon service provision system and method using mobile communication terminal”)

### SUMMARY

The present invention is directed to providing a differential reward provision method and apparatus for providing a differential point which provides an additional point when satisfying a reward condition based on user condition including user information and purchase information and reward condition information.

One aspect of the present invention provides a point provision apparatus, including: a storage module including a user information database (DB) for managing information of a user member, an affiliated store information DB for managing information of an affiliated store member, and a reward condition information DB for managing reward condition information set for each affiliated store; a member management module configured to receive user information and affiliated store information from a user terminal and an affiliated store terminal, respectively, to construct the user information DB and the affiliated store information DB, and set a purchase condition for the affiliated store registered in the affiliated store information DB and a reward condition based on a user condition to construct the reward condition information DB; and a reward processing module configured to inquire the user information and the reward condition based on purchase information when the purchase information is received from the affiliated store terminal, compare the inquired user information and the received purchase information with the reward condition, confirm whether to satisfy the reward condition, and provide an additional point to the user according to whether to satisfy the reward condition.

In the point provision apparatus according to an embodiment of the present invention, when the number of the satisfied reward conditions is a plural, the reward processing module may provide by summing the additional point allocated to each reward condition.

In the point provision apparatus according to an embodiment of the present invention, the storage module may further include a loyalty level information DB for managing a loyalty level for each user set according to an accumulation amount of an accumulation point, wherein the reward processing module may inquire the loyalty level of a corresponding user from the loyalty level information DB based on the received purchase information, and provide the additional point by considering the inquired loyalty level.

In the point provision apparatus according to an embodiment of the present invention, the reward condition may include one or more among a purchase cost, a purchase date, a purchase period (frequency), the number of accumulation purchase times, a visiting distance, and a loyalty level.

Further, in the point provision apparatus according to an embodiment of the present invention, the reward condition may include one or more conditions corresponding to any one of the purchase condition and the user condition, and a logical operation between the one or more conditions.

Another aspect of the present invention provides a point provision method, including: setting a reward condition based on a purchase condition and a user condition for each affiliated store; receiving purchase information from one or more affiliated stores; inquiring user information and a reward condition of a corresponding affiliated store based on the received purchase information; comparing the inquired user information and the received purchase information with the reward condition, and confirming whether to satisfy the reward condition; and determining an additional point according to whether to satisfy the reward condition.

In the point provision method according to an embodiment of the present invention, the determining of the additional point may determine an additional point allocated to the reward condition when there is information satisfying the reward condition in the inquired user information and the received purchase information, and determine by summing the additional point allocated to each reward condition when the number of the reward conditions which is satisfied is a plural.

Further, the point provision method according to an embodiment of the present invention may further include: inquiring a loyalty level determined according to an accumulation point of the user based on the received purchase information, wherein the determining of the additional point may determine the additional point by further considering the loyalty level.

In the point provision method according to an embodiment of the present invention, the reward condition may include one or more conditions corresponding to any one of the purchase condition and the user condition, and a logical operation between the one or more conditions, and include one or more among a purchase cost, a purchase date, a purchase period (frequency), the number of purchase times, a visiting distance, and a loyalty level.

Still another aspect of the present invention provides a computer-readable recording medium in which a program for executing the point provision method described above is recorded.

The present invention can increase a satisfaction to consumption behavior of a customer, and induce a continuous purchase effect of the customer by additionally providing the differential point for each customer according to whether to satisfy the reward condition which is previously set.

Also, the present invention can provide an effective marketing service by providing the additional point according to various reward conditions, and contribute to an increase of sales of the affiliated store by promoting the consumption behaviors of much more customers.

Further, the present invention can provide a loyalty level according to the accumulation point, and thus stimulate the purchase need of the customer and increase the loyalty level of the customer by differentially providing the point accumulation amount or ratio.

Moreover, the present invention can remove the inconvenience in which the customer keeps a separate coupon or directly present the separate coupon in order to get the additional point.

Particularly, the present invention can provide a much more differential reward by considering not only purchase information but also user information by setting the reward condition considering both of a user condition based on the user information and a purchase condition based on the purchase information.

### BRIEF DESCRIPTION OF DRAWINGS

FIG. 1 is a schematic diagram illustrating an entire configuration of a point provision system according to an exemplary embodiment of the present invention;

FIG. 2 is a diagram illustrating a detailed configuration of a point provision apparatus for a differential reward according to an exemplary embodiment of the present invention;

FIG. 3 is a diagram for describing a service to which a differential reward method is applied in a point provision system according to one exemplary embodiment of the present invention;

FIG. 4 is a flowchart for describing a differential reward method in the point provision apparatus according to one exemplary embodiment of the present invention;

FIG. 5 is a diagram for describing a service procedure to which a differential reward method is applied in a point provision system according to another exemplary embodiment of the present invention;

FIG. 6 is a flowchart for describing a differential reward method in the point provision apparatus according to another exemplary embodiment of the present invention;

FIG. 7 is a flowchart for describing a method of determining whether to raise a loyalty level in the differential reward method of the point provision apparatus according to another exemplary embodiment of the present invention;

FIG. 8 is a diagram illustrating a structure of a reward condition information database (DB) according to one exemplary embodiment of the present invention;

FIG. 9 is a diagram illustrating a structure of a reward condition information DB according to another exemplary embodiment of the present invention; and

FIG. 10 is a diagram illustrating an operating environment of a point provision apparatus to which the present invention is executed.

### DETAILED DESCRIPTION

The above and other objects, features, and advantages of the present invention will become more apparent to those of ordinary skill in the art by describing in detail exemplary embodiments thereof with reference to the accompanying drawings.

A detailed description of well-known functions or configurations which can obscure a subject matter of the present invention in the following descriptions and accompanying drawings will be omitted. Further, throughout the drawings, it will be understood that the same or similar elements are designated by like reference numerals.

The terminology and vocabulary used below to describe the specification and claims should not be construed as general or dictionary meanings, and based on a principle in which an inventor may appropriately define the terminology and vocabulary as concepts to describe the invention in the best way, the terminology and vocabulary should be interpreted as the meanings and the concepts corresponding to a technical spirit of the invention. Accordingly, constructions shown in the embodiments and drawings described in the specification are merely the preferred embodiments, and since the constructions do not show all the technical spirits of the present invention, it will be understood that there are various equivalents and modifications capable of replacing them at the time of filing an application.

Also, it will be understood that, although the terms “first,” “second,” etc. may be used herein to describe various elements, these elements should not be limited by these terms. These terms are only used to distinguish one element from another. For example, a first element, a first component, or a first section could be termed a second element, a second component, or a second section, and a second element, a second component, or a second section could be termed a first element, a first component, or a first section without departing from the scope of the inventive concept.

Further, it will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

Moreover, the terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The exemplary embodiments of the present invention may include a computer-readable medium storing or carrying a computer-executable instruction or a data structure stored in the computer-readable medium. The computer-readable medium may be an arbitrary usable medium which can be accessed by a general-purpose or specific-purpose computer system. Examples of the computer-readable medium may include a random access memory (RAM), a read only memory (ROM), an electrically programmable read only memory (EPROM), a compact disk (CD)-ROM, other optical disk storage device, a magnetic disk storage device, or other magnetic storage device, and may be used for storing or carrying a predetermined program code means in the form of a computer-executable instruction, a computer-readable instruction, or a data structure, and may include a physical storage medium such as another arbitrary medium which can be accessed by the general-purpose or specific-purpose computer system but is not limited thereto.

In the following description and claims, a “network” may be defined as one or more data links capable of transmitting electronic data between computer systems and/or modules. When information is transmitted or provided to the computer system through the network or another (a wired, a wireless, or a combination of wired and wireless) communication connection, it will be understood that the connection is the computer-readable medium. For example, the computer-readable instruction may include an instruction and data which allows the general-purpose or specific-purpose computer system to perform a specific function or a group of functions. For example, the computer-executable instruction may be an assembly language, or a binary or intermediate format instruction such as even a source code.

Also, in the following description and claims, a “point” may be defined as a point which is able to be accumulated which is provided to a user corresponding to a use of an on-line/off-line service, for example, a purchase of a product or a service by an electronic commerce, a sale, a log-in, an execution of the on-line/off-line service such as a game/video on demand (VOD)/search/download, etc., and may be referred to as another name such as a mileage, etc.

The present invention may set a differential reward condition according to member information and purchase information, and provide a point to a user according to the set reward condition when providing a point according to a use result of the on-line/off-line service.

The present invention may be performed in a network computing environment having configurations of various types of computer systems including a personal computer (PC), a laptop computer, a hand-held device, a multi-processor system, a microprocessor-based or programmable consumer electronic product, a network PC, a minicomputer, a mainframe computer, a mobile telephone, a personal digital assistant (PDA), a pager, etc. The present invention may be performed in a distributed system environment in which both of a local and a remote computer systems linked by a wired data link, a wireless data link, or a combination of the wired and the wireless data links perform a task through a network. In the distributed system environment, a program module may be located in both local and remote storage devices.

First, a configuration of a differential reward apparatus according to an exemplary embodiment of the present invention will be described in detail with reference to the accompanying drawings.

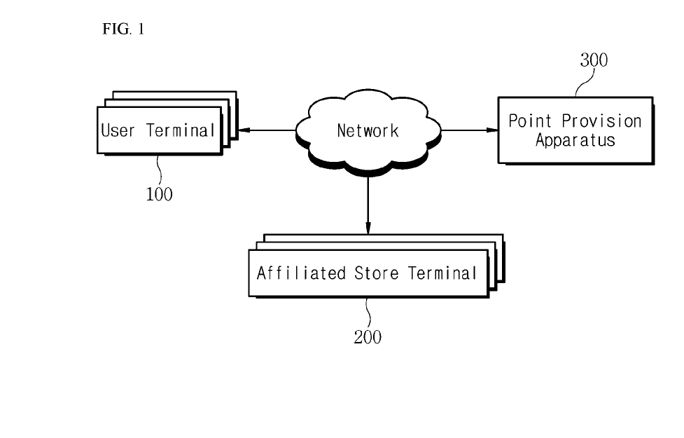

FIG. 1 is a schematic diagram illustrating an entire configuration of a point provision system according to an exemplary embodiment of the present invention.

Referring to FIG. 1, a point provision system may include one or more user terminals 100, one or more affiliated store terminals 200, and a point provision apparatus 300, which are connected through a network.

The user terminal 100 according to the present invention may be an electronic device capable of transceiving various kinds of data through the network according to manipulation of a key by a user, and may be any one among a tablet PC, a laptop computer, a PC, a smart phone, a PDA, a smart television (TV), and a mobile communication terminal, etc.

Further, the user terminal 100 may be an electronic device performing voice or data communication using the network, and may mean an electronic device including a browser for communicating with the point provision apparatus 300 through the network, a memory storing a program and a protocol, and a microprocessor for calculating and controlling by executing various kinds of programs, etc. That is, the user terminal 100 may be any kind of electronic device which performs server-client communication with the point provision apparatus 300 and executes a customized service, and in a broader concept, may include a communication computing device such as a notebook computer, a mobile communication terminal, a PDA, etc. Meanwhile, it may be desired that the user terminal 100 is manufactured in the form including a touch screen, but is not limited thereto.

The user terminal 100 may transceive data according to a point provision service by communicating with the point provision apparatus 300 connected through the network. For example, the user terminal 100 may receive a point which is additionally accumulated whenever purchasing a product and accumulation point information from the point provision apparatus 300. At this time, the point which is additionally accumulated and the accumulation point information may be provided through a message service such as a short message service (SMS), a multimedia messaging service (MMS), an instant message (IM), etc.

The affiliated store terminal 200 according to an exemplary embodiment of the present invention may be an electronic device capable of transceiving data for a use of the point provision service by communicating with the point provision apparatus 300 through the network, and may be a point-of-sale (POS) system.

The affiliated store terminal 200 according to an exemplary embodiment of the present invention may transmit purchase information of a customer to the point provision apparatus 300 through the network, and receive the determined additional point and accumulation point information. In this case, the affiliated store terminal 200 may output the received additional point and accumulation point information in a payment receipt when purchasing.

The point provision apparatus 300 according to an exemplary embodiment of the present invention may have a configuration performing a differential point reward service by interworking with one or more user terminals 100 and one or more affiliated store terminals 200 through the network, and integrally manage a point of the customer according to a point payment and accumulation, etc.

The point provision apparatus 300 may receive purchase information of the customer from the affiliated store terminal 200 through the network, performs a point reward operation determining whether to provide the additional point for the received purchase information, and provide the determined result to the user terminal 100 and/or the affiliated store terminal 200. Here, the result according to the point reward operation may include the additional point information which is additionally provided and the accumulation point information.

That is, the point provision apparatus 300 according to an exemplary embodiment of the present invention may provide a basic point in a fixed ratio according to the purchase of the customer, determine whether to provide a differential additional point according to whether to satisfy a reward condition based on customer information including member information input when joining to be a member and the purchase information and a reward condition which is previously set, and provide the additional point to a corresponding customer to accumulate it when satisfying the reward condition. Here, the reward condition may include a user condition as well as a purchase condition, and may be set for each affiliated store or equally for all of the affiliated stores. In more detail, the reward condition may be formed by one or more conditions corresponding to any one of the purchase condition and the user condition, and a combination of a logical operation function of the one or more conditions. For example, the logical operation function may mean a logical operator such as AND, OR, NOR, XOR, etc. The one or more conditions corresponding to any one of the purchase condition and the user condition may include a purchase cost, a purchase date, a visiting distance, a purchase period (frequency), the number of accumulation purchase times, and a loyalty level, etc.

A detailed configuration of the point provision apparatus according to an exemplary embodiment in the point provision system configured as described above will be described in detail with reference to the accompanying drawing.

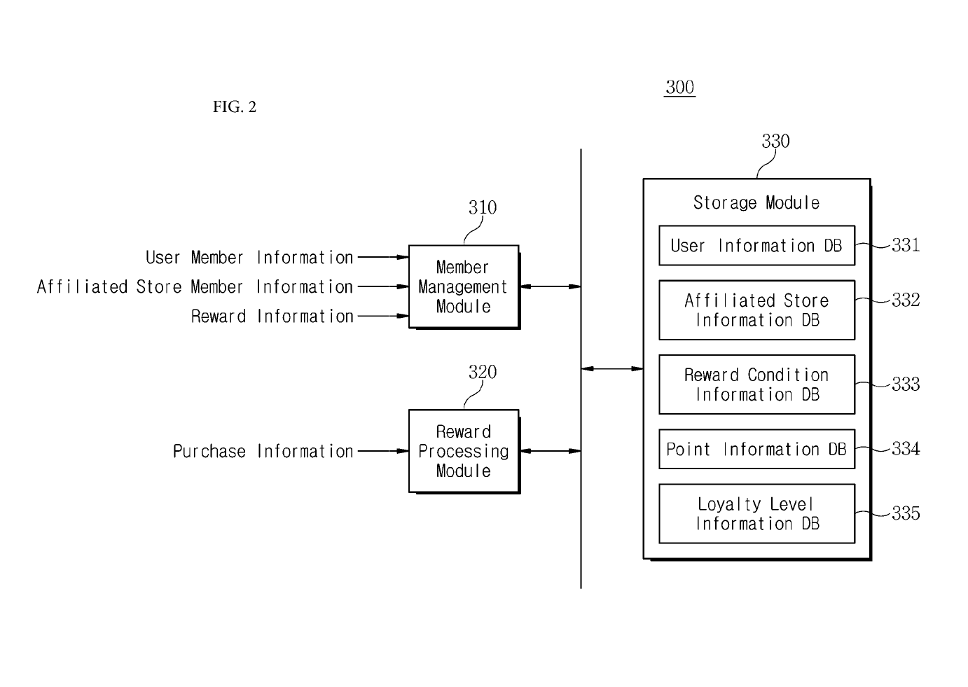

FIG. 2 is a diagram illustrating a detailed configuration of the point provision apparatus 300 in the point provision system according to an exemplary embodiment of the present invention.

Referring to FIG. 2, the point provision apparatus 300 according to an exemplary embodiment of the present invention may include a member management module 310, a reward processing module 320, and a storage module 330. Here, the “module” may be a component performing a predetermined function, and may be implemented by hardware, software, or a combination of the hardware and the software. For example, the “module” may mean a program module, and the program module may perform the predetermined function by being executed by a processor.

The member management module 310 according to an exemplary embodiment of the present invention may set and manage member information related to a differential reward according to the present invention. In the present invention, the members may be classified as a user member and an affiliated store member. The user member may use the on-line/off-line service, and mean a member to which a point is differentially rewarded based on the use of the on-line/off-line service, and the affiliated store member may provide the on-line/off-line service, and mean a member of providing the point.

The member management module 310 may receive the user information related to the user member from the user terminal 100, manage by registering the user information in a user information database (DB) 331, receive the affiliated store member information from the affiliated store terminal 200, and manage by registering the received affiliated store member information in an affiliated store information DB 332.

The user information may include one or more among user identification (ID) information, a name, an address, a job, a gender, etc. Further, the member management module 310 may set the reward condition for the differential point reward service according to a request from the affiliated store terminal 200, and manage the reward condition for each affiliated store by registering the set reward condition in a reward condition information DB 333.

When receiving a information request message including the purchase information of the customer from the affiliated store terminal 200, the reward processing module 320 may compare the user information and the purchase information of the customer with the reward condition of a corresponding affiliated store terminal 200, determine whether to provide the additional point for the purchase information of the customer which is received, and provide the additional point information and the accumulation point information provided besides the basic point to the user terminal 100 and/or the affiliated store terminal 200.

Here, the purchase information of the customer may include customer ID information, affiliated store ID information, a purchase date, a purchase cost, etc., the customer ID information may be information capable of identifying a member such as a member number allocated when joining to be a member in the affiliated store or the customer name and telephone number, or ID information read by scanning a member card, etc., and the affiliated store ID information may be information capable of identifying the affiliated store such as ID information allocated when joining the differential point reward service.

For example, the reward processing module 320 according to an exemplary embodiment of the present invention may perform the differential point reward service of providing by confirming whether to satisfy the reward condition based on the purchase date, the visiting distance, the purchase frequency (period), the number of accumulation purchase times, etc., and differentiating the additional point.

The storage module 330 according to an exemplary embodiment of the present invention may manage relevant information for providing the differential point reward service, and be recorded in a hardware storage medium or a data module (a file system or a database system) recorded in the hardware storage medium and storing the information.

The storage module 330 may include the user information DB 331, the affiliated store information DB 332, the reward condition information DB 333, and a point information DB 334. Further, in another exemplary embodiment of the present invention, the storage module 330 may further include a loyalty level information DB 335.

For example, the storage module 330 may include a magnetic media such as a hard disk, a floppy disk, and a magnetic tape, an optical media such as a CD-ROM, a DVD, a magneto-optical media such as a floptical disk, a ROM, a RAM, and a flash memory.

The user information DB 331 according to an exemplary embodiment of the present invention may store information of a user member among members joined in the differential point reward service, and here, the user information may be registered through the affiliated store terminal 200 or be directly registered from the customer by interworking between the user terminal 100 and the point provision apparatus 300. Further, the user information may include a name, a birth date, a telephone number, a electronic mail address, a residence address, etc., of the customer. In this case, the user information DB 331 and the affiliated store information DB 332 may be implemented to be interworked. For example, the user information of the user information DB 331 may be stored by being mapped to the affiliated store registered in the affiliated store information DB 332.

The affiliated store information DB 332 according to an exemplary embodiment of the present invention may store information of the affiliated store which is affiliated with the differential point reward service, and the affiliated store information may include a store name, a business type, a telephone number, an address, a business registration number, etc. The affiliated store information may be stored by being mapped to the affiliated store ID information.

The reward condition information DB 333 according to an exemplary embodiment of the present invention may manage the previously set reward condition which is a reference condition for the differential reward, and may include condition information for a purchase item (product), a purchase date, a visiting distance, a purchase frequency (period), the number of accumulation purchase times, etc. The reward condition may be differently set for each affiliated store, or be equally set for all or each portion of the affiliated stores. For example, the reward condition may be set so as to provide the additional point when purchasing a specific product for promoting a new product or clearing a product in stock for each affiliated store.

For another example, the reward condition may be set to provide the additional point when using a non-peak time zone rather than a peak time zone for every affiliated store, using in weekdays rather than a weekend, or using on a specific day. A more additional point may be set to be provided in proportion to the number of reward conditions which is satisfied.

Particularly, in the present invention, the reward condition may be set based on the purchase condition set based on an item corresponding to the purchase information, and the user condition set based on an item corresponding to the user information.

Here, the purchase condition may be a condition set based on information generated based on a purchase behavior such as the purchase cost, the purchase date, the purchase period (frequency), the number of accumulation purchase times, etc. The purchase date in the purchase condition may be further classified as a peak time zone/a non-peak time zone, weekdays/weekend, each day of week.

Next, the user condition may be a condition generated based on the user information, and for example, the user condition may be the visiting distance to the affiliated store based on the residence address registered when a user joins to be a member, and the visiting distance may be classified in units of a predetermined distance. The reward condition may include one or more conditions corresponding to any one of the purchase condition and the user condition, and further, include one or more conditions and a logical operation function between the one or more conditions.

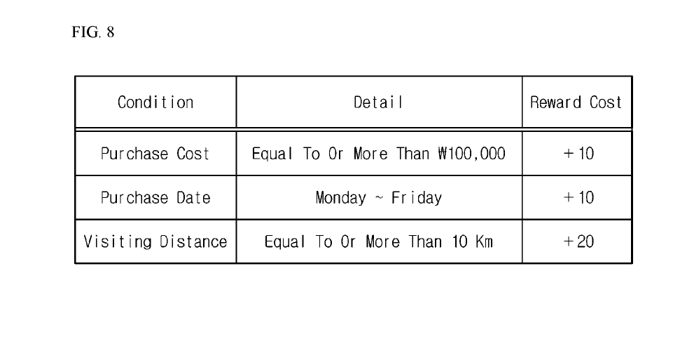

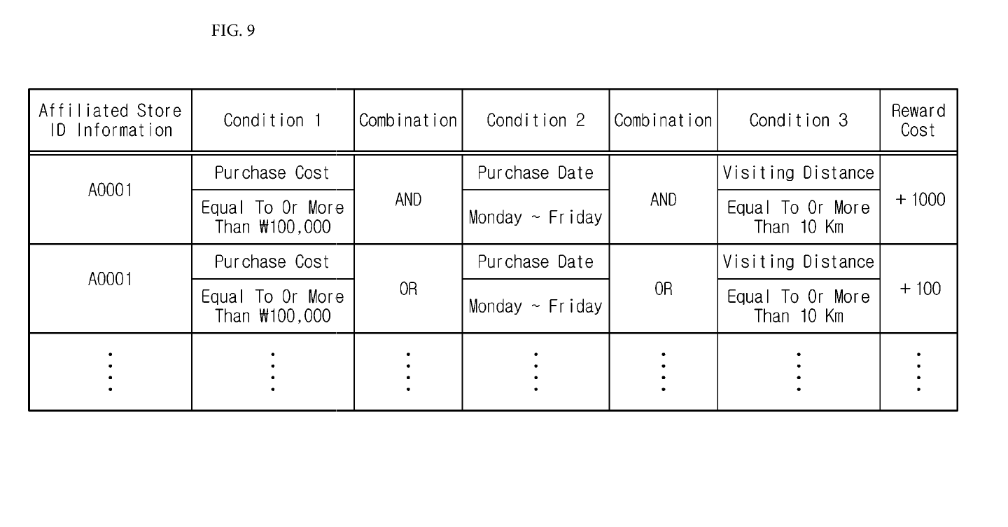

FIGS. 8 and 9 are diagrams illustrating a data structure of the reward condition information DB 333, respectively, according to exemplary embodiments of the present invention.

Referring to FIG. 8, in one exemplary embodiment of the present invention, the reward condition may be set to include one or more conditions for each affiliated store, and the condition may be set to include items different from each other.

That is, as shown in FIG. 8, the reward condition may include three conditions, and the three conditions may be the purchase cost which is equal to or more than [symbol] 100,000, the purchase date which is from Monday to Friday, and the visiting distance which is equal to or more than 10 Km. In this case, a reward cost corresponding to each condition may be set, that is, the additional point may be set for each condition.

In this case, the reward processing module 320 may confirm whether to satisfy the three conditions included in the reward condition based on the purchase information and the user information inquired based on the purchase information, and determine a sum of the reward costs set for the satisfied conditions as the additional point.

For example, when a user living in a place which is away by 13 Km from the affiliated store purchases a product of [symbol] 150,000 and pays the cost in the affiliated store on Wednesday, the additional point of total 40 points may be accumulated for the user.

Further, referring to FIG. 9, in another exemplary embodiment of the present invention, the reward condition may include one or more conditions for each affiliated store, and a logical operation function for logically combining the one or more conditions.

For example, two reward conditions may be set for the affiliated store in which the affiliated store ID information is identified as A0001. In this case, one of the two reward conditions may be obtained by an AND operation of conditions 1, 2, and 3 corresponding to the purchase cost which is equal to or more than [symbol] 100,000, the purchase date which is from Monday to Friday, and the visiting distance which is equal to or more than 10 Km, respectively, and the other of the two reward conditions may be obtained by an OR operation of the conditions 1, 2, and 3.

Accordingly, when the user living in a place which is away by 13 Km from the affiliated store purchases a product of [symbol] 150,000 and pays the cost in the affiliated store on Wednesday, the additional point of total 1,000 points may be accumulated for the user. On the other hand, when the user living in a place which is away by 9 Km from the affiliated store purchases a product of [symbol] 150,000 and pays the cost in the affiliated store on Sunday, the additional point of total 100 points may be accumulated for the user.

Accordingly, the member management module 310 may set the reward condition shown in FIGS. 8 and 9 according to a request from the affiliated store terminal 200, and provide a user interface for setting the reward condition.

Next, the point information DB 334 according to an exemplary embodiment of the present invention may store a point accumulation approval detail allocated for each user, and store the accumulation point information, the basic point and additional point information which are recently approved, for the customer.

The loyalty level information DB 335 according to an exemplary embodiment of the present invention may store loyalty level information set for each user based on the accumulation point information.

The user information DB 331, the affiliated store information DB 332, the reward condition information DB 333, and the loyalty level information DB 335 may be updated by the member management module 310, and the point information DB 334 may be updated by the reward processing module 320.

A method for the differential point reward service in the point provision system configured as described above will be described in detail with reference to the accompanying drawings. First, an operation for the differential point reward service in the point provision system will be described according to one exemplary embodiment of the present invention.

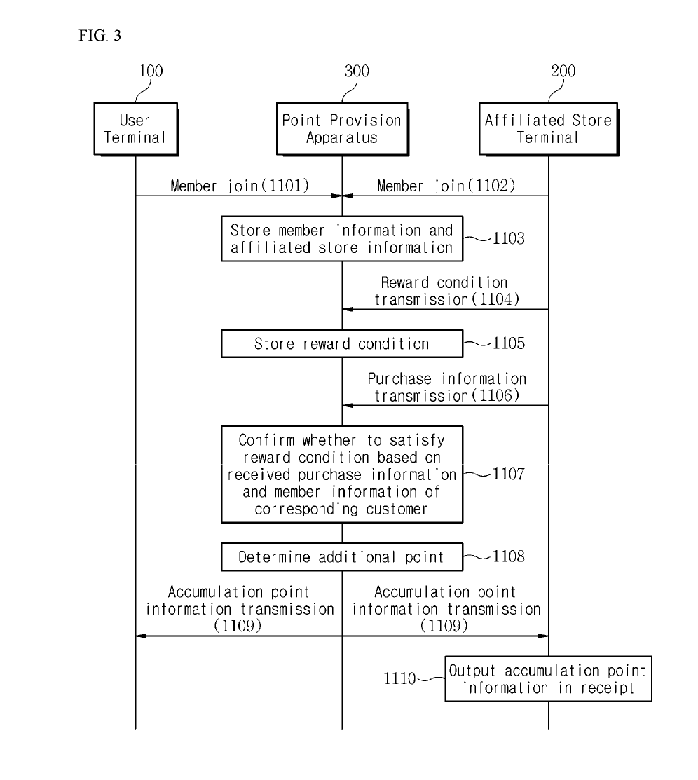

FIG. 3 is a diagram for describing a differential reward operation in a point provision system according to one exemplary embodiment of the present invention.

Referring to FIG. 3, in operation 1101, the customer may join to be a member in order to use the differential point reward service provided from the point provision apparatus 300 through the user terminal 100.

The user terminal 100 may receive an application for the differential point reward service from the point provision apparatus 300 and install the application, and simply perform a point inquiry according to the differential point reward service, a user information correction, etc. after joining to be the member by connecting to the point provision apparatus 300. The point provision apparatus 300 may collect the user information of the user member in the process of joining to be the member.

Meanwhile, in one exemplary embodiment of the present invention, the operation of directly joining to be the member through the user terminal 100 is described, but is not limited thereto, and an operation of joining to be the member through the affiliated store terminal 200 may be performed.

In operation 1102, the affiliated store member may establish an alliance for the differential point reward service provided from the point provision apparatus 300 through the affiliated store terminal 200, and join to be a member. The point provision apparatus 300 may collect the affiliated store information of the affiliated store member through the operation of joining to be the member.

For reference, the affiliated store terminal 200 may receive the application for the differential point reward service according to the service alliance from the point provision apparatus 300 and install the application, and perform the differential point reward service.

That is, the affiliated store terminal 200 may transmit the purchase information and the user ID information (the name, the telephone number, etc.) to the point provision apparatus 300 when the purchase of the product or the use of the service is established, and receive the point accumulation information including the basic point and the additional point for the purchase of this time.

Next, in operation 1103, the point provision apparatus 300 may store the user information and the affiliated store information input through the user terminal 100 and the affiliated store terminal 200 in the user information DB 331 and the affiliated store information DB 332 of the storage module 330.

After this, the point provision apparatus 300 may perform the differential reward service corresponding to the use of the on-line/off-line service between the affiliated store and the user using the user information and the affiliated store information which are stored. For example, the point provision apparatus 300 may calculate the visiting distance based on the residence address of the user information and the affiliated store address of the affiliated store information, and provide the additional point when the visiting distance is included in the specific section.

For this, in operation 1104, the point provision apparatus 300 may set the reward condition for a corresponding affiliated store according to a request from the affiliated store terminal 200. That is, the point provision apparatus 300 may receive reward condition set information from the affiliated store terminal 200, and set the reward condition for the corresponding affiliated store.

Here, the reward condition may include one or more conditions corresponding to any one of the purchase conditions such as the purchase item, the purchase date, the visiting distance, the purchase frequency (period), the number of accumulation purchase times, etc. and the user condition. Further, the reward condition may include a logical operation function between the one or more conditions.

For example, the reward condition may be set by combining the visiting distance and the purchase frequency by an AND operation, or be set by combining the purchase frequency, the number of accumulation purchase times, and the visiting distance by an OR operation.

Further, each of the visiting distance, the purchase frequency (period), and the number of accumulation purchase times may be classified into a plurality of sections, and the additional point for each section may be differentially set. For example, as the visiting distance is far, the purchase frequency is high, and the number of accumulation purchase times is great, a more additional point may be provided.

Next, in operation 1105, the point provision apparatus 300 may store the set reward condition in the reward condition information DB 332 by classifying the reward condition for each affiliated store. Here, the point provision apparatus 300 may provide a search and an inquiry for the point reward condition of each affiliated store which is previously stored according to a request from the customer.

After this, in operation 1106, the affiliated store terminal 200 may generate the purchase information according to the purchase behavior of the customer, and transmit the generated purchase information to the point provision apparatus 300. The purchase information may include the user ID information, the affiliated store ID information, the purchase item, the purchase cost, the purchase date, etc.

In operation 1107, the point provision apparatus 300 may inquire the reward condition of a corresponding affiliated store based on the purchase information transmitted from the affiliated store terminal 200, and confirm whether to satisfy the reward condition for the user information and the purchase information of the customer.

That is, when the point provision apparatus 300 confirms whether to satisfy the reward condition for the corresponding affiliated store from the user information and the purchase information of the customer, referring to FIG. 9, the point provision apparatus 300 may compare the user information and the purchase information with the conditions 1, 2, and 3, confirm whether to satisfy the conditions 1, 2, and 3, and finally determine whether to satisfy the reward condition by logically calculating whether to satisfy the conditions 1, 2, and 3.

Next, in operation 1108, the point provision apparatus 300 may determine the additional point according to the result of whether to satisfy the reward condition performed based on the user information and the purchase information of the customer and the set reward condition. Here, an accumulation amount of the additional point may be determined in proportion to a corresponding item and the number of the reward conditions which is satisfied. Accordingly, the accumulation point including the basic point and the additional point according to the purchase of this time may be finally determined.

In operation 1109, the point provision apparatus 300 may transmit the accumulation point information including the basic point, and the determined additional point and accumulation point to the user terminal 100 and the affiliated store terminal 200. Here, the point provision apparatus 300 may not transmit the accumulation point information to the user terminal 100.

After this, in operation 1110, the affiliated store terminal 200 may output the accumulation point information transmitted from the point provision apparatus 300 together with a payment detail in a receipt.

Although not shown, the point provision apparatus 300 may store the received purchase information and the determined accumulation point information in the point information DB 334.

A detailed method for the differential point reward service in the point provision apparatus according to the operation for the differential point reward service as described above will be described below.

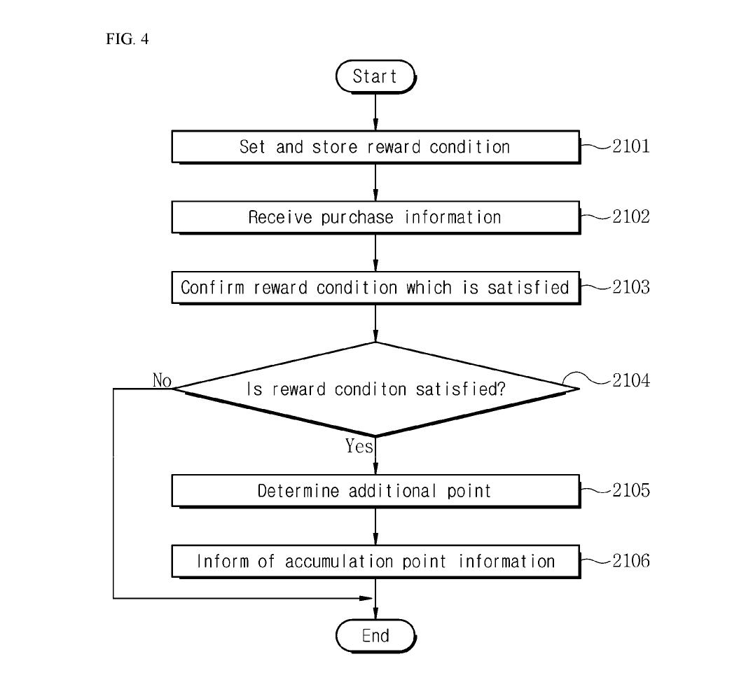

FIG. 4 is a diagram for describing a point provision method in the point provision apparatus 300 according to one exemplary embodiment of the present invention.

Referring to FIG. 4, first, the point provision apparatus 300 may construct the user information DB 331 and the affiliated store information DB 332 using the user information input when joining to be the member and the affiliated store information registered according to a service alliance.

Next, in operation 2101, the point provision apparatus 300 may set the reward condition by interworking with the affiliated store terminal 200, and store the reward condition for each affiliated store by constructing the reward condition information DB 333.

Next, in operation 2102, the point provision apparatus 300 may receive the purchase information from the affiliated store terminal 200. The purchase information may include the customer ID information, the affiliated store ID information, the purchase item, the purchase date, etc., and when the user member purchases a product or uses a service from the affiliated store on-line or off-line, the purchase information may be generated and be transmitted to the point provision apparatus 300.

In operation 2103, the point provision apparatus 300 may confirm whether to satisfy the reward condition using the received purchase information.

In more detail, the point provision apparatus 300 may inquire the user information of a corresponding customer using the customer ID information included in the received purchase information, inquire the reward condition of a corresponding affiliated store using the affiliated store ID information included in the received purchase information, compare the received purchase information and user information with the inquired reward condition of the affiliated store, and confirm whether to satisfy the reward condition.

Continuously, when it is confirmed that the reward condition is satisfied in the operation 2104, in operation 2105, the point provision apparatus 300 may determine the additional point to be provided according to the satisfied reward condition, and store the determined additional point in the point information DB 334.

Next, in operation 2106, the point provision apparatus 300 may inform the affiliated store terminal 200 and/or the user terminal 100 of the accumulation point information including the basic point, and the additional point and the accumulation point which are determined.

Meanwhile, when it is confirmed that the reward condition is not satisfied in the operation 2104, the point provision apparatus 300 may proceed to the operation 2106, and inform the affiliated store terminal 200 and/or the user terminal 100 of the accumulation point information including the basic point and the accumulation point.

Next, in another exemplary embodiment of the present invention, the differential reward may be performed by further considering the loyalty level together with the reward condition. That is, in another exemplary embodiment of the present invention, an accumulation ratio of the basic point and the additional point may be different according to the loyalty level.

For example, in another exemplary embodiment of the present invention, the reward processing module 320 may set the purchase cost and the accumulation amount of the basic point and the additional point for each reward condition in proportion to the loyalty level and store the set purchase cost and the accumulation amount, and when the purchase information is received from the affiliated store terminal 200, determine the basic point and the additional point based on the loyalty level after inquiring the loyalty level of a corresponding customer.

On the other hand, the reward processing module 320 may store by setting the accumulation ratio of each loyalty level, and when the basic point and the additional point are determined after the purchase information is received from the affiliated store terminal 200, inquire the loyalty level of the corresponding customer, and finally determine by recalculating the accumulation ratio to the additional point according to the inquired loyalty level.

The loyalty level may be raised when the accumulation point of the customer is more than a threshold value set for each level, the accumulation ratio of the point is increased or the accumulation amount of the point may be adjusted, a congratulation point or a product purchase coupon of the corresponding affiliated store, etc. may be provided, whenever the level is raised.

For this, the reward processing module 320 according to another exemplary embodiment of the present invention may previously set the accumulation ratio of the point to the loyalty level and the threshold value for determining whether to raise the level. Through this, the reward processing module 320 according to another exemplary embodiment of the present invention may perform the differential point reward service by allocating the loyalty level to the customer together with confirming whether to satisfy the reward condition according to the purchase date, the visiting distance, the purchase frequency (period), the number of purchase times, etc., and differentially allocating the accumulation ratio of the point.

Further, the loyalty level information DB 335 may store the basic point provided for each loyalty level and the additional point information for each reward condition, and store the accumulation ratio information of the point set for each loyalty level. Here, the loyalty level may classify a sum of the accumulation points for each section, and the classified accumulation point section may be set as one level.

An operation for the differential reward service according to another exemplary embodiment of the present invention will be described.

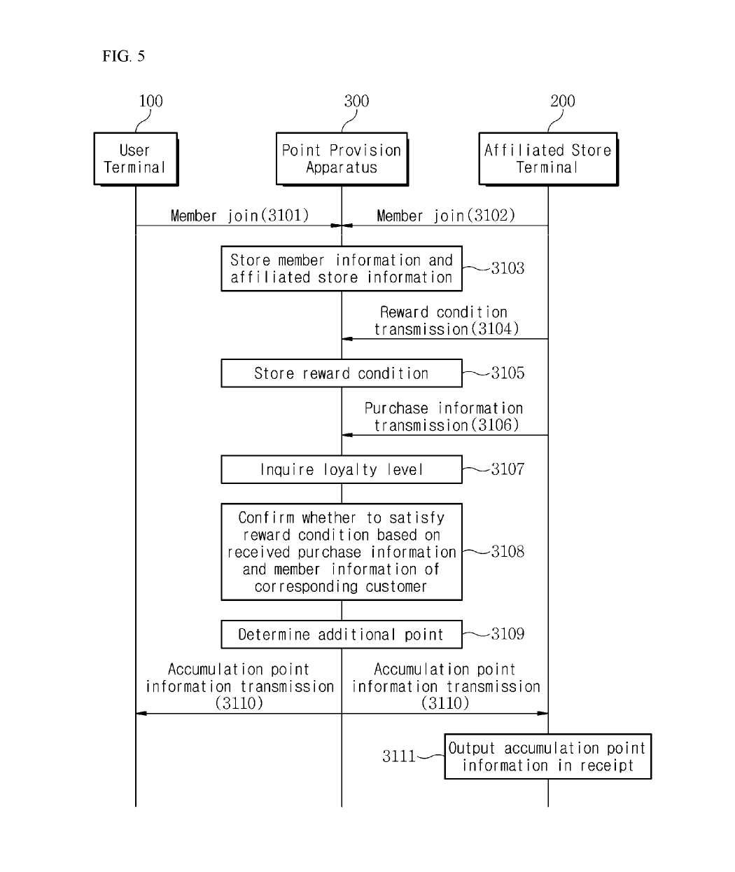

FIG. 5 is a diagram for describing an operation for a differential reward service in a point provision system according to another exemplary embodiment of the present invention.

Here, since the operation for the differential reward service according to another exemplary embodiment of the present invention is identical to the operation for the differential reward service according to one exemplary embodiment of the present invention shown in FIG. 3 when excluding an operation of inquiring the loyalty level of the customer and determining the accumulation ratio of the point according to the inquired loyalty level, only the operation of inquiring the loyalty level and determining the accumulation ratio of the point according to the inquired loyalty level will be described and a description for the identical operation will be omitted.

That is, since operations 3101 to 3106 are identical to the operations 1101 to 1106 shown in FIG. 3, a duplicated description thereof will be omitted, and an operation after the purchase information is received will be described.

Referring to FIG. 5, in operation 3107, when the purchase information transmitted from the affiliated store terminal 200 is received, the point provision apparatus 300 may inquire the loyalty level of a corresponding customer based on the user ID information included in the received purchase information.

The loyalty level may be adjusted by determining whether to raise the loyalty level by comparing the point accumulated whenever the point provision apparatus 300 accumulates the point with a point range which is previously set for each loyalty level. Accordingly, the loyalty level of the user which is adjusted may be stored in the loyalty level information DB 335.

Further, in operation 3108, the point provision apparatus 300 may inquire the user information and the reward condition of the corresponding affiliated store based on the user ID information and the affiliated store ID information included in the purchase information received from the affiliated store terminal 200, and confirm whether to satisfy the reward condition for the user information and the purchase information of the customer. That is, the point provision apparatus 300 may confirm whether there is an item corresponding to the reward condition for the corresponding affiliated store from the user information and the purchase information of the customer. Here, the reward condition may include one or more conditions corresponding to any one of the purchase condition and the user condition, and further include the logical operation function between the one or more conditions. Here, the logical operation function may mean a logical operator such as AND, OR, NOR, XOR, etc. The one or more conditions corresponding to any one of the purchase condition or the user condition may include the purchase cost, the purchase date, the visiting distance, the purchase period (frequency), the number of accumulation purchase times, and the loyalty level, etc.

For example, when the reward condition is set as shown in FIG. 9, the point provision apparatus 300 may compare the purchase cost included in the purchase information with the purchase cost of the condition 1 and determine whether to satisfy the condition 1, compare the purchase date included in the purchase information with the purchase date (the condition 2) included in the reward condition and determine whether to satisfy the condition 2, and calculate the visiting distance which is from the residence address included in the user information to the affiliated store, compare the calculated visiting distance with the visiting distance of the condition 3, and determine whether to satisfy the condition 3.

Additionally, whether to satisfy the reward condition may be finally determined by logically ANDing and ORing the determination results of whether to satisfy the conditions 1, 2, and 3.

Next, in operation 3109, the point provision apparatus 300 may determine the additional point according to the determination result of whether to satisfy the reward condition performed based on the user information and the purchase information of the customer and the set reward condition. Here, the accumulation amount of the additional point may be differentially set according to the loyalty level of the customer inquired in the operation 3107, and the additional point may be adjusted with reference to the loyalty level. Further, the accumulation amount of the additional point may be determined in proportion to a corresponding item and the number of the reward conditions which are satisfied. Accordingly, the accumulation point including the basic point and the additional point according to the purchase of this time may be finally determined.

Accordingly, in operation 3110, the point provision apparatus 300 may transmit the accumulation point information including the basic point and the additional point and the accumulation point which are determined to the user terminal 100 and the affiliated store terminal 200. Here, the point provision apparatus 300 may transmit the accumulation point information only to the affiliated store terminal 200, and not transmit it to the user terminal 100.

After this, in operation 3111, the affiliated store terminal 200 may output the accumulation point information transmitted from the point provision apparatus 300 together with a payment detail in a receipt.

Meanwhile, in the operation 3109, the point provision apparatus 300 may determine whether the accumulation point according to the purchase of this time is more than the threshold point set for determining whether to raise the loyalty level, and when it is determined that the accumulation point according to the purchase of this time is more than the threshold point, raise the loyalty level, and further provide the congratulation point according to the raised loyalty level.

Next, in the operation 3110, the point provision apparatus 300 may transmit the accumulation point information including the basic point, and the determined additional point, the congratulation point according to the raised loyalty level, and the accumulation point to the user terminal 100 and the affiliated store terminal 200. In this case, the point provision apparatus 300 may transmit the raised information of the loyalty level together with the accumulation point information to each of the user terminal 100 and the affiliated store terminal 200.

Accordingly, in operation 3111, the affiliated store terminal 200 may output the accumulation point information and the raised information of the loyalty level transmitted from the point provision apparatus 300 together with the payment detail in the receipt.

A detailed method for the differential point reward service in the point provision apparatus according to the operation for the differential point reward service will be described below.

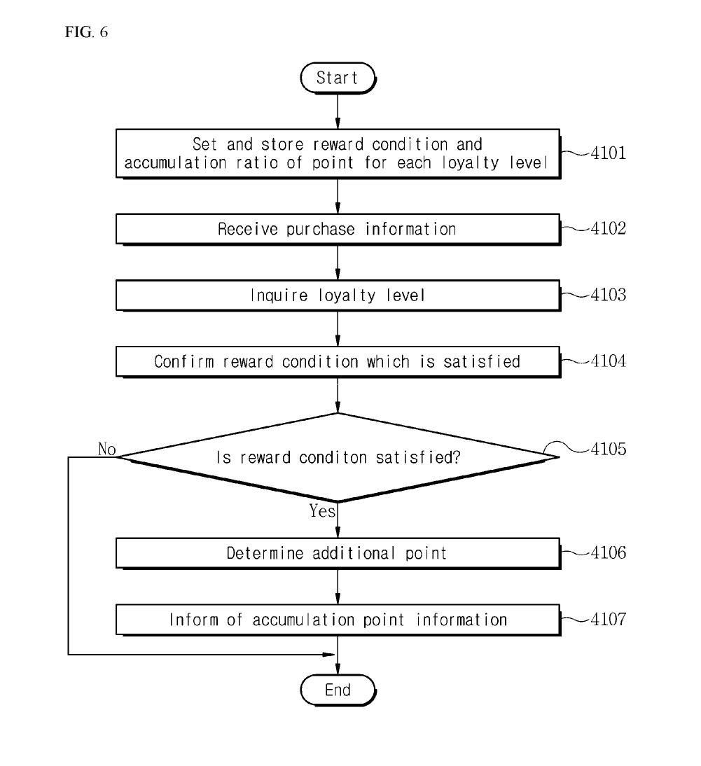

FIG. 6 is a diagram for describing the differential reward method in the point provision apparatus according to another exemplary embodiment of the present invention. Here, since the differential reward method in the point provision apparatus according to another exemplary embodiment of the present invention is identical to the differential reward method in the point provision apparatus according to one exemplary embodiment of the present invention shown in FIG. 4 when excluding an operation of inquiring the loyalty level of the customer and determining the accumulation ratio of the point according to the inquired loyalty level, only the operation of inquiring the loyalty level of the customer and determining the accumulation ratio of the point according to the inquired loyalty level will be described, and a description for the identical operation will be omitted.

Referring to FIG. 6, in operation 4101, the point provision apparatus 300 may store by setting the accumulation ratio of the point for each loyalty level or the basic point and the accumulation amount of the additional point for the reward condition which are differentially set for each loyalty level and, and store by setting the reward condition and the accumulation amount of the additional point according to the reward condition.

After this, when the purchase information is received in the operation 4102, in operation 4103, the point provision apparatus 300 may inquire the user information and the reward condition of the affiliated store based on the user ID information included in the purchase information, and also inquire the loyalty level of the corresponding customer based on the user ID information.

In operation 4104, the point provision apparatus 300 may confirm the reward condition satisfied based on the received purchase information and the inquired user information.

Continuously, when it is confirmed that the reward condition is satisfied in the operation 4105, in operation 4106, the point provision apparatus 300 may determine the additional point according to the reward condition which is satisfied and the loyalty level (operation 4106). Here, when the number of the reward conditions which are satisfied is a plural, the additional point may be finally determined by summing the additional points set for each reward condition.

Next, in operation 4107, the point provision apparatus 300 may inform the user terminal 100 and/or the affiliated store terminal 200 of the accumulation point information including the basic point, and the additional point and the accumulation point which are determined.

Meanwhile, when it is confirmed that the reward condition is not satisfied in the operation 4105 (N), in the operation 4107, the point provision apparatus 300 may inform the user terminal 100 and/or the affiliated store terminal 200 of the accumulation point information including the basic point and the accumulation point.

In the differential reward service of the point provision apparatus 300 as described above, the loyalty level may be adjusted according to the on-line/off-line service use result of the user.

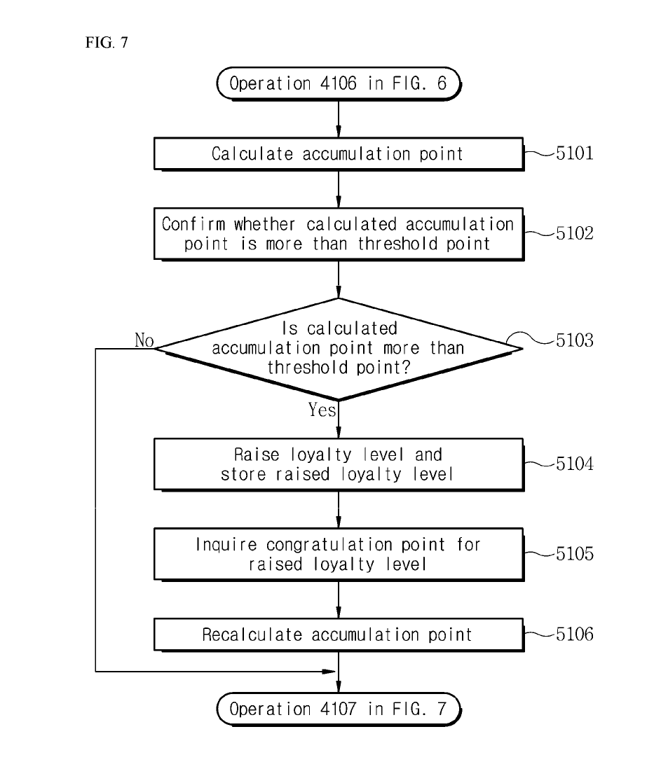

FIG. 7 is a flowchart for describing a method of determining a point by further considering a loyalty level in detail, in the differential reward method of the point provision apparatus 300 according to another exemplary embodiment of the present invention.

Referring to FIG. 7, when the additional point is determined according to whether to satisfy the reward condition in the operation 4106 of FIG. 6, in operation 5101, the point provision apparatus 300 may calculate the accumulation point of this time by summing the basic point, the additional point, and a current accumulation point.

Next, in operation 5102, the point provision apparatus 300 may confirm whether the calculated accumulation point is more than the threshold point set for determining whether to raise the loyalty level with respect to the accumulation point of this time which is calculated.

Next, when it is determined that the accumulation point of this time which is calculated is more than the threshold point in operation 5103, in operation 5104, the point provision apparatus 300 may raise the loyalty level, and update the loyalty level information DB 335 for reflecting the raised loyalty level.

In operation 5105, the congratulation point which is previously set for the raised loyalty level may be inquired. Here, as the loyalty level is raised, a more congratulation point may be set to be provided, or the same congratulation point may be set to be provided regardless of the loyalty level.

After this, in operation 5106, the point provision apparatus 300 may recalculate the final accumulation point by summing the inquired congratulation point to the accumulation point calculated in the operation 5101.

Next, in the operation 4107 of FIG. 6, the point provision apparatus 300 may inform the user terminal 100 and/or the affiliated store terminal 200 of the accumulation point information including the accumulation point which is finally calculated.

Meanwhile, when it is determined that the accumulation point of this time which is calculated is not more than the threshold point in the operation 5103, the point provision apparatus 300 may proceed to the operation 4107 of FIG. 6 without recalculating the point according to the loyalty level.

Each operation according to exemplary embodiments of the present invention described above may be implemented by a computer-executable instruction and be executed by a computing system. Here, the “computing system” may be defined as one or more software modules, one or more hardware modules, or a combination of them operating together with an operation on electronic data. For example, the computing system may include a software module such as an operating system of a PC and a hardware component of the PC. A physical layout of the module is not important. The computing system may include one or more computers connected through a network.

Likewise, the computing system may be implemented by one physical device in which an internal module such as a memory and a processor operates together with the operation on the electronic data.

That is, the point provision apparatus 300 according to the exemplary embodiment of the present invention may be implemented to perform the exemplary embodiments described above based on a computing system which will be described below.

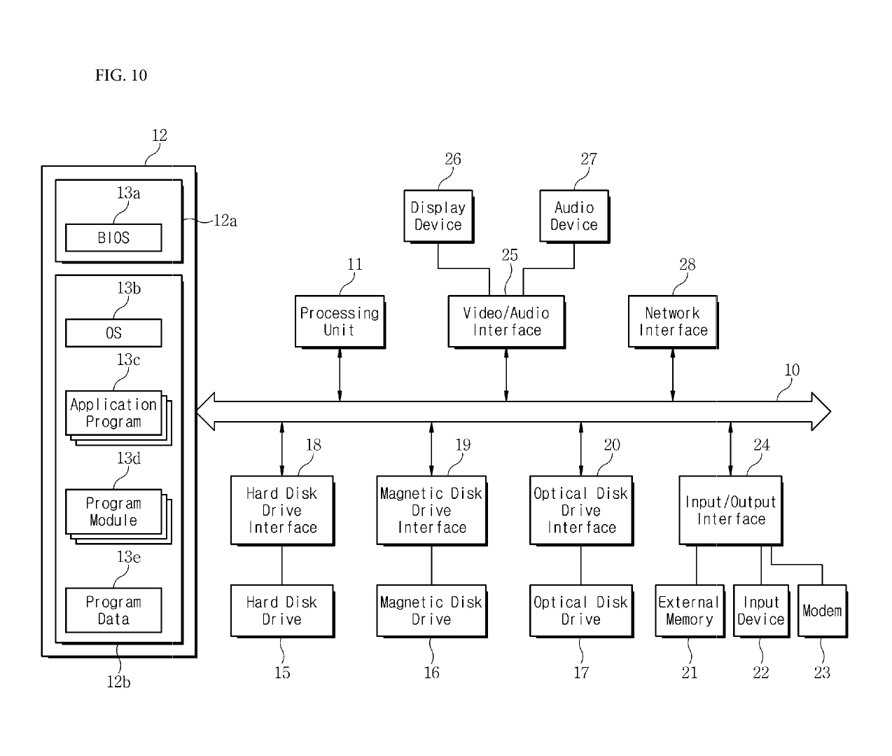

FIG. 10 is a diagram illustrating an example of a computing environment in which the present invention is performed.

FIG. 10 and the following description may provide a simple and general description of a proper computing environment in which the present invention is able to be implemented. Although not required, the present invention will be described in the general context of a computer-executable instruction such as a program module which is being executed by the computing system. Generally, the program module may include routines, programs, objects, components, data structures, etc., which perform a specific task or implement a specific abstract data type. The computer-executable instruction, an associated data structure, and the program module may represent an example of the program code means for executing the operation of the present invention disclosed herein.

Referring to FIG. 10, the computing system for implementing the present invention includes a computing device having a configuration including a processing unit 11, a system memory 12, and a system bus 10 connecting various system components including the system memory 12 to the processing unit 11.

The processing unit 11 may execute a computer-executable instruction designed to implement features of the present invention.

The system bus 10 may be any of several types of bus structures including a local bus, a peripheral bus, a memory bus or a memory controller using any of a variety of bus architectures. The system memory 12 includes a ROM 12a and a RAM 12b. A basic input/output system (BIOS) 13a including a basic routine that helps to transfer information between elements within the computing system, such as during start-up, may be stored in the ROM 12a.

The computing system may also include storage devices including, for example, a hard disk drive 15 for reading information from or writing information to a hard disk, a magnetic disk drive 16 for reading information from and writing information to a magnetic disk, and an optical disk drive 17 for reading information from or writing information to an optical disk, such as, for example, a CD-ROM or other optical media. The hard disk drive 15, magnetic disk drive 16, and optical disc drive 17 are connected to the system bus 10 by a hard disk drive interface 18, a magnetic disk drive interface 19, and an optical drive interface 20, respectively.

In addition, the computing system may further include an external memory 21 as the storage device. The external memory 21 may be connected to the system bus 10 through an input and output interface 24.

The above-described drives and associated computer-readable media which are read and recorded by the drives may provide nonvolatile storage of a computer-executable instruction, a data structure, a program module, and other data. Although the example environment described herein employs the hard disk 15, the magnetic disk 16, and the optical disk 17, other types of the computer-readable media for storing data which include a magnetic cassette, a flash memory card, a digital versatile disk (DVD), a Bernoulli cartridge, a RAM, a ROM, etc. may be used.

The program code means including one or more program modules including an operating system 13b, one or more application programs 13c, other program modules 13d, and program data 13e, which are loaded and executed by the processing unit 11, may be stored on the hard disk 15, the magnetic disk 16, the optical disk 17, the ROM 12a, or the RAM 12b.

Moreover, the computing system may receive a command and information from a user through other input devices 22 such as a keyboard, a pointing device, a microphone, a joy stick, a game pad, a scanner, etc. These input devices 22 can be connected to the processing unit 11 through the input and output interface 24 connected to the system bus 10. The input and output interface 24 logically represents any of a wide variety of possible interfaces, such as a serial port interface, a PS/2 interface, a parallel port interface, a Universal Serial Bus (USB) interface, or an Institute of Electrical and Electronics Engineers (IEEE) 1394 interface (i.e., a FireWire interface), or may even logically represent a combination of different interfaces.

In addition, the computing system to which the present invention is applied may further include a display device 26 such as a monitor or liquid crystal display (LCD) or an audio device 27 such as a speaker or microphone. The display device 26 and the audio device 27 may be connected to the system bus 10 through a video/audio interface 25. For example, other peripheral output devices (not shown), such as a speaker and a printer, may also be connected to the computing system 420. The video/audio interface 25 may include a high definition multimedia interface (HDMI), a graphics device interface (GDI), etc.

In addition, the computing system may be connectable to networks, such as an office-wide or enterprise-wide computer network, a home network, an intranet, and/or the Internet. The computing system may exchange data with external sources, such as a remote computer system, a remote application, and/or a remote database through the networks.

The computing system to which the present invention is applied may include a network interface 28 for receiving data from external sources and/or transmitting data to external sources.

In the present invention, the computing system for the point provision apparatus 300 may perform data exchange with the user terminal 100 and the affiliated store terminal 200 located in a remote position through the network interface 28. For example, the network interface 28 may be represented by a logical combination of one or more software and/or hardware modules, such as a network interface card and a corresponding network driver interface specification (NDIS) stack.

Likewise, the computing system may receive data from external sources and/or transmit data to external sources through the input and output interface 24. The input and output interface 24 may be connected to a modem 23 (for example, a standard modem, a cable modem, or a digital subscriber line (DSL) modem), and the computing system may receive data from and/or transmit data to external sources through the modem 23.

While FIG. 10 represents a proper operating environment for the present invention, the principles of the present invention may be employed in any system capable of implementing the principles of the present invention, with suitable modification if necessary. The environment illustrated in FIG. 10 is illustrative only and may not represent even a small portion of the wide variety of environments in which the principles of the present invention are able to be implemented.

According to the present invention, the program module including the member management module 310, the reward processing module 320, the user information DB 331, the affiliated store information DB 332, the reward condition information DB 333, the point information DB 334, and the loyalty level information DB 335 may be stored in the any computer-readable medium related to the computing system shown in FIG. 8 and be accessible. For example, a portion of the program module and a portion of associated program data may be included in the operating system 13b, the application program 13c, the program module 13d, and/or the program data 13e, for storage in the system memory 12.

When a mass storage device, such as a hard disk, is connected to the computing system, the program module and associated program data may also be stored in the mass storage device. In a network environment, the program module associated with the present invention, or a portion thereof, can be stored in the remote memory storage device, such as, the system memory and/or the mass storage device associated with a remote computer system, for example, the computing system of the user terminal 100 and the affiliated store terminal 200, connected through the modem 23 of the input and output interface 24 or the network interface 28. As described above, execution of the module may be performed in a distributed environment.

The specification includes details of a number of specific implementations, but it should be understood that the details do not limit any invention or what is claimable in the specification but rather describe features of the specific embodiment. Features described in the specification in the context of individual embodiments may be implemented as a combination in a single embodiment. In contrast, features described in the specification in the context of a single embodiment may be implemented in multiple embodiments individually or in an appropriate sub-combination. Furthermore, the features may operate in a certain combination and may be initially described as claimed in the combination, but one or more features may be excluded from the claimed combination in some cases, and the claimed combination may be changed into a sub-combination or a modification of a sub-combination.

Similarly, even though operations are described in a certain order in the drawings, it should not be understood that the operations be executed in the certain order or in a sequential order to obtain desired results, or that all of the operations be executed. In some cases, a multitasking and a parallel processing may be beneficial. In addition, it should not be understood that the separation of various system components in the above described embodiments is required in all embodiments, and it should be understood that the above described program components and systems may be incorporated into a single software product or may be packaged in multiple software products.

Thus, particular embodiments have been described. Other embodiments are within the scope of the following claims. For example, the operations recited in the claims can be performed in a different order and still achieve desirable results. As an example, operations depicted in the drawings in a particular order should not be understood as requiring that such operations be performed in the particular order shown or in sequential order. In a specific implementation, multitasking and parallel processing may be advantageous.

The description suggests the best mode of the present invention to provide an example that explains the present invention and also enables one skilled in the art to manufacture and use the present invention. The specification drafted as such is not limited to detailed terms suggested in the specification. Accordingly, it will be apparent to those skilled in the art that various modifications, changes, and variations may be made in the example without departing from the scope of the invention.

Accordingly, the scope of the present invention should be defined not by the embodiments but by the claims.

The present invention may be provided to the use of the on-line/off-line service, and more particularly, to technology of providing the reward corresponding to the on-line/off-line transaction to the user, and be applied to a payment system for the electronic commerce field and off-line transactions.

Particularly, the present invention can increase a satisfaction to consumption behavior of the customer, and induce a continuous purchase effect of the customer by additionally providing the differential point for each customer according to whether to satisfy the reward condition which is previously set in the on-line/off-line transaction.

Further, the present invention can perform an effective marketing service by providing the additional point according to various reward conditions, and increase sales of the affiliated store by promoting the consumption behaviors of much more customers.

Moreover, the present invention can provide the loyalty level according to the accumulation point, and increase the loyalty of the customer by differentially providing the accumulation amount or ratio of the point and thus promoting the purchase need of the customer.

The present invention can remove the inconvenience in which the customer keeps a separate coupon or directly present the separate coupon in order to get the additional point.

Particularly, the present invention can provide a more differential reward by considering the user information as well as merely the purchase information by setting the reward condition considering the user condition based on the user information and the purchase condition based on the purchase information.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A point provision apparatus, comprising:
a storage module including a user information database (DB) for managing information of a user member, an affiliated store information DB for managing information of an affiliated store member, and a reward condition information DB for managing reward condition information set for each affiliated store;
a member management module configured to receive user information and affiliated store information from a user terminal and an affiliated store terminal, respectively, to construct the user information DB and the affiliated store information DB, and set a purchase condition for the affiliated store registered in the affiliated store information DB and a reward condition based on a user condition to construct the reward condition information DB; and
a reward processing module configured to inquire the user information and the reward condition based on purchase information when the purchase information is received from the affiliated store terminal, compare the inquired user information and the received purchase information with the reward condition, confirm whether to satisfy the reward condition, and provide an additional point to the user according to whether to satisfy the reward condition.

2. The point provision apparatus of claim 1, wherein, when the number of the satisfied reward conditions is a plural, the reward processing module provides by summing the additional point allocated to each reward condition.

3. The point provision apparatus of claim 1, wherein the storage module further comprises a loyalty level information DB for managing a loyalty level for each user set according to an accumulation amount of an accumulation point,
wherein the reward processing module inquires the loyalty level of a corresponding user from the loyalty level information DB based on the received purchase information, and provides the additional point by considering the inquired loyalty level.

4. The point provision apparatus of claim 1, wherein the reward condition includes one or more among a purchase cost, a purchase date, a purchase period (frequency), the number of accumulation purchase times, a visiting distance, and a loyalty level.

5. The point provision apparatus of claim 1, wherein the reward condition includes one or more conditions corresponding to any one of the purchase condition and the user condition, and a logical operation between the one or more conditions.

6. A point provision method, comprising:
setting a reward condition based on a purchase condition and a user condition for each affiliated store;
receiving purchase information from one or more affiliated stores;
inquiring user information and a reward condition of a corresponding affiliated store based on the received purchase information;
comparing the inquired user information and the received purchase information with the reward condition, and confirming whether to satisfy the reward condition; and
determining an additional point according to whether to satisfy the reward condition.

7. The point provision method of claim 6, wherein the determining of the additional point determines an additional point allocated to the reward condition when there is information satisfying the reward condition in the inquired user information and the received purchase information, and determines by summing the additional point allocated to each reward condition when the number of the reward conditions which is satisfied is a plural.

8. The point provision method of claim 7, further comprising:
inquiring a loyalty level determined according to an accumulation point of the user based on the received purchase information,
wherein the determining of the additional point determines the additional point by further considering the loyalty level.

9. The point provision method of claim 7, wherein the reward condition includes one or more conditions corresponding to any one of the purchase condition and the user condition, and a logical operation between the one or more conditions.

10. The point provision method of claim 7, wherein the reward condition includes one or more among a purchase cost, a purchase date, a purchase period (frequency), the number of purchase times, a visiting distance, and a loyalty level.

11. A non-transitory computer-readable recording medium in which a program for executing the point provision method cited in claim 6 is recorded.
